(19) United States
(12) Patent Application Publication
(10) Pub. No.: US 2014/0025426 A1
(43) Pub. Date: Jan. 23, 2014

(54) WORKFLOW ADAPTATION USING AUTOMATED MODEL TRANSFORMATION

(71) Applicants: MARKUS DOEHRING, Weinheim (DE); Ivan Galkin, Karlsruhe (DE); Axel Schulz, Bensheim (DE)

(72) Inventors: MARKUS DOEHRING, Weinheim (DE); Ivan Galkin, Karlsruhe (DE); Axel Schulz, Bensheim (DE)

(21) Appl. No.: 13/555,210

(22) Filed: Jul. 23, 2012

(51) Int. Cl. G06Q 10/06

(52) U.S. Cl. 705/7.27

(57) ABSTRACT

Various embodiments of systems and methods for adapting a reference workflow, according to changing data-contexts, during execution are described herein. The method involves detecting an entry to an adaptive segment in the reference workflow and invoking data context variables associated with the adaptive segment. Further the method includes invoking a set of ordered adaptation rules comprising a set of constraints on the data context variables. In an aspect, the method includes evaluating the rule-set using the one or more data context variables associated with the workflow. Based on the evaluation, a list of adaptation patterns is generated and provided as input to a pattern selector. In another aspect, adaptation patterns from the list of adaptation patterns are recursively called by the pattern selector. The called adaptation patterns are then executed as sub-processes within the adaptive segment.

### FIELD

The field relates generally to workflow management systems (WMS). More specifically, the field relates to dynamically adapting the workflow to changing business requirements, at the time of execution of the workflow, using a model transformation approach.

### BACKGROUND

Workflow management systems (WtMS) have become an essential part of many industrial IT system landscapes as companies increasingly implement their business processes using workflow management concepts and technology, such as SAP NetWeaver™ Business Process Management (BPM) or SAP® Business Workflow. Motivated by rapidly changing business requirements which have to be instantaneously integrated into workflow definitions or even running workflow instances, a whole branch of BPM research is concerned with the provisioning of advanced control-flow flexibility concepts for workflow modeling and execution. For example, a company may have to cope with a number of process variants due to customer, product, or country specific characteristics. Such changes within the business environment as well as internal or external regulations may necessitate not only altering the process logic for newly started workflow instances, but also adjusting already existing workflow instances.

However, contemporary workflow-driven BPM systems do not yet support this degree of flexibility. In traditional BPM solutions one can try to solve this modeling challenge by putting each possible variant in one specific model. But this might lead to an unmaintainable number of models containing partly redundant business logic. Another possibility would be to combine all variants in one workflow model. But this would lead to a huge and unmaintainable workflow model.

### SUMMARY

Various embodiments of systems and methods for workflow adaptation using automated model transformation are described herein. In one aspect, a method for adapting a reference workflow during execution, to changing data-contexts involves detecting an entry to an adaptive segment in the reference workflow and invoking data context variables associated with the adaptive segment. Further, the method includes invoking a set of ordered rules that specify the type of workflow adaptation to be performed when a particular constraint is met. In an aspect, the method includes evaluating the constraints in the set of rules using the one or more data context variables. Based on the evaluation, one or more adaptation patterns associated with the fulfilled constraints are identified and a list of adaptation patterns is generated. The list of adaptation patterns is then provided as input to a pattern selector. In another aspect, adaptation patterns from the list of adaptation patterns are recursively called by the pattern selector. The called adaptation patterns are then executed as sub-processes within the adaptive segment.

In another embodiment, a method for generating a workflow adaptation model involves identifying one or more segments of a reference workflow as a segment that may be subject to variations during execution of the workflow and marking the identified segments as adaptive segments. In an aspect, the adaptive segments are demarcated using special node types indicating a start and end of the adaptive segment. In a further aspect, the method includes configuring a set of adaptation patterns, where an adaptation pattern includes a placeholder for adopting a context-specific behavior. In another aspect, one or more adaption rules are formulated to define constraints for invoking an adaptation pattern from the set of adaptation patterns. In yet another aspect, a pattern selector is configured to recursively call a nested list of adaptation patterns where, the nested list is generated during execution by evaluating the constraints in the adaptation rules using one or more data context variables associated with the adaptive segment.

These and other benefits and features of embodiments will be apparent upon considering the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a flow diagram of a method for automated model transformation, according to one embodiment.

FIG. 2 is a flow diagram of a method for dynamically adapting workflow instances during execution, according to one embodiment.

FIG. 3 is a block diagram of an exemplary workflow illustrating business process deviations, according to one embodiment.

FIG. 4 is a block diagram of a business process model.

FIG. 5 is a block diagram of an exemplary reference workflow, according to one embodiment.

FIG. 6 is a block diagram of an exemplary workflow implementing pattern-based adaptations during execution, according to one embodiment.

FIG. 7 illustrates the input models for generating a BPMN2 compliant model, according to one embodiment.

FIGS. 8A to 8C illustrate a model generation process for generating BPMN2 compliant model, according to one embodiment.

FIG. 9 illustrates a resulting BPMN2 compliant model, according to one embodiment.

FIG. 10 depicts an execution of a nested set of adaptation patterns within an execution engine, according to one embodiment.

FIG. 11 illustrates an adaptation pattern catalogue, according to one embodiment.

FIG. 12 illustrates a block diagram of an exemplary computer system configured in accordance with an embodiment.

### DETAILED DESCRIPTION

Embodiments of techniques for workflow adaptation using automated model transformation are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

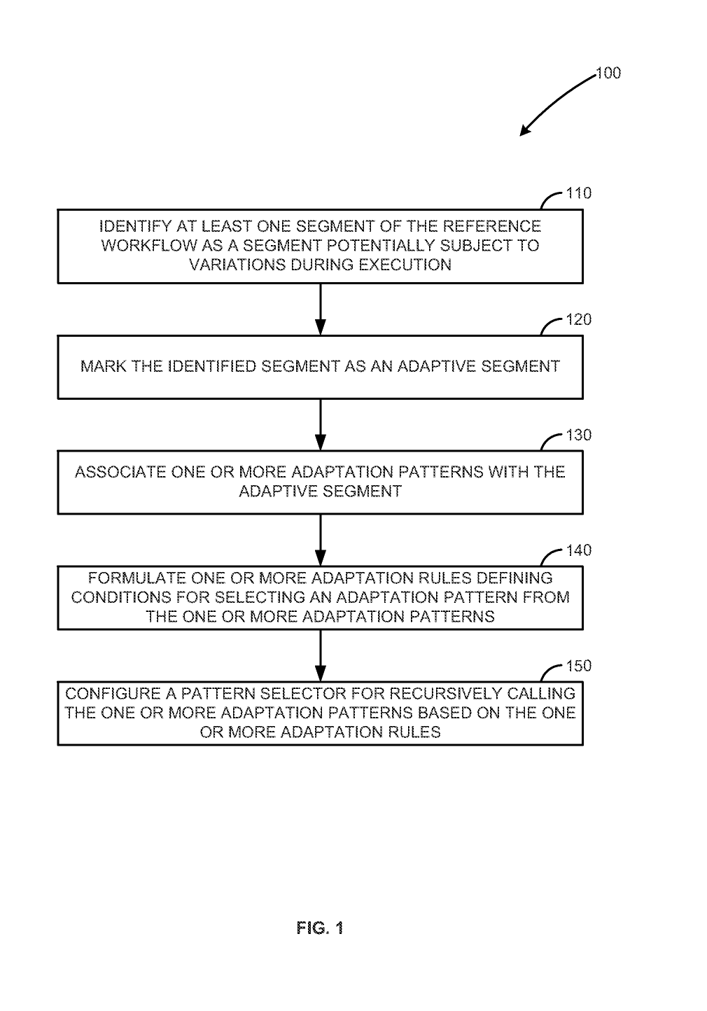

The method 100 in FIG. 1 is implemented by a computer or any other electronic device having processing capabilities, in a workflow management system. In another embodiment, the workflow management system is integrated with an Enterprise Resource Planning (ERP) system having a plurality of business systems which are integrated to each other over a communication network. In an embodiment, the workflow management system is an on-demand workflow management solution in which software and associated data are hosted centrally, e.g., on the Internet and accessed by a computer using a web browser. FIG. 1 illustrates a flow diagram of a method 100 for configuring an input model for a reference workflow adaptation process, according to an embodiment. The term “workflow” as used herein refers to the automation of a business process, in whole or part, during which documents, information or tasks are passed from one resource (participant or machine) to another for action, according to a set of procedural rules. For example, the transition of a task from one resource to another may be enabled by one or more triggers or by the result of actions performed at previous stages of the business process. Examples of triggers include user trigger, message trigger, automatic trigger, and timed trigger. A workflow is formed of a set of workflow instances. The term “reference workflow” as used herein refers to a standardized (regular) course of the business process. Workflows typically represent real world business processes, and as a result, they are subject to change as the real world context changes. The method 100 of FIG. 1 describes one exemplary way of configuring a reference workflow to be adaptive to change during execution, for instance.

In an aspect, at process block 110, one or more segments of a reference workflow are identified as variant segments. For example, those segments of a reference workflow that may be subject to adaptations during the execution of the reference workflow are identified as variant segments. In an aspect, the choice of the type of adaptations to be applied to the variant segment is ruled by the current values of the data-context variables associated with the variant segments. Data context-variables refer to data that characterizes the context in which the workflow is executed. Examples of the context in which the workflow is executed include events, facts, demography, customer type, product type, geography, policies, standards, rules, etc. A particular course of workflow taken by a workflow instance depending on the data-context variables is termed as a “context-specific behavior.” For example, a change in the data-context variables triggers a change in the context-specific behavior. Examples of context-specific behavior include skipping a workflow instance, performing an additional workflow instance in parallel, performing additional action based on data context variables, and the like.

At process block 120, the identified one or more variant segments are configured as adaptive segments. In an aspect, the one or more variant segments of the reference workflow are configured as adaptive segments by demarcating the one or more variant segments using a distinct node type. In an example, the variant segments are configured as adaptive segments by enclosing the variant segment with opening and closing square brackets. These are mere examples whereas one of ordinary skill in art will recognize that other methods of demarcation can also be just as effective. In an example scenario, consider a reference workflow for ship engine maintenance. The regular course of the reference workflow includes engine startup tests, lifetime analysis tests, and spare parts inspection as workflow instances. However, the spare parts inspection segment may be subject to adaptations during execution, such as, inspecting the spare parts on the ship only if the customer has a positive credit report. Considering such possibilities, the spare parts inspection segment is identified as a variant segment. The identified variant segment is then configured as an adaptive segment by enclosing the variant segment with distinct node types.

At process block 130, a set of adaptation patterns are configured and associated with the adaptive segment. An adaptation pattern defines how a deviation of an adaptive segment from a reference process should be conducted and contains a placeholder for the adaptive segment for accommodating possible deviations. In an aspect, the adaptation patterns are configured as a browsable catalogue of reusable adaptation patterns.

At process block 140, one or more adaptation rules are formulated comprising constraints for invoking an adaptation pattern from the set of adaptation patterns. The adaptation rules establish a relation between a workflow instance and constraints for selecting an adaptation pattern. In an aspect, the adaptation rules are formulated in an event-condition-action (ECA) format. The “event” prong in the rule corresponds to the entry event of an adaptive segment. The “condition” prong corresponds to value restrictions (constraints) on data-context variables. The “action” prong corresponds to the application of adaptation patterns to a workflow instance being executed. The data-context variables refer to data characterizing the context associated with the workflow instance. Examples of data-context variables include, but are not limited to, good's value, customer status, geography, demography, environmental conditions, nature of goods, and historical data. In the given example, the adaptation rule is formulated in the ECA format as follows:

<ON SparePartsInspection_entry IF Customercredit=low THEN skip Spare Parts inspection>

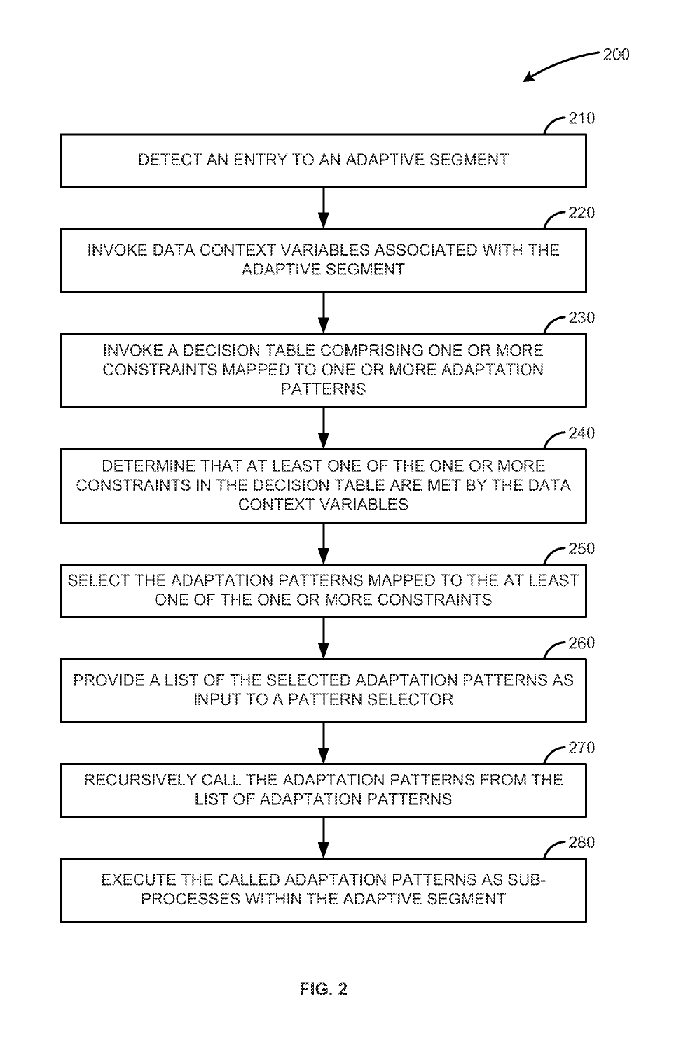

In an embodiment, the adaptation rules assigned to an adaptive segment are evaluated at the time of executing the workflow, using the data-context variables associated with the workflow. Based on the evaluation, more than one adaptation may have to be executed depending on the number of constraints that were fulfilled by evaluating the adaptation rules. In an aspect, in order to execute the multiple adaptations, the adaptation patterns corresponding to the adaptations are nested, i.e., wrapped one after the other around the adaptive segment, such that calling one of the adaptation patterns, executes the adaptation as a sub-process and wraps back to another adaptation pattern, until all the multiple adaptation patterns are executed. In an aspect, at process block 150, a pattern selector is configured for recursively calling the nested list of adaptation patterns, where the nested list is generated based on evaluating the one or more adaptation rules using one or more data context variables associated with the adaptive segment. The input model configured as illustrated by process blocks 110-150 enables the dynamic adaptation of the workflow model at the time of execution as described in more detail with reference to FIG. 2.

FIG. 2 illustrates a flow diagram of a method 200 for performing workflow adaptations using the input model described with reference to FIG. 1, according to an embodiment. In an aspect, at process block 210, during execution of a reference workflow, an entry to an adaptive segment in the reference workflow is detected. For example, an entry to the adaptive segment is detected by detecting a distinct node type associated with the adaptive segment. The distinct node type may be represented using one or more conventions such as with opening or closing square brackets (“[ ]”) such that an entry to the adaptive segment is detected by identifying an open square bracket “[.” At process block 220, upon detecting an entry to the adaptive segment, the data context variables associated with the adaptive segment is invoked.

Further, at process block 230, upon detecting an entry to an adaptive segment, a decision table associated with the adaptive segment is invoked. The decision table includes fields representing one or more constraints on the data-context variables. Further, the decision table includes one or more adaptation patterns mapped to the one or more constraints. In an aspect, the one or more constraints and associated adaptation patterns are specified in the fields of the decision table by personnel associated with the business process. In another aspect, the one or more constraints are derived from the condition prong of the adaptation rules which are formulated in the event-condition-action (ECA) format. The adaptation patterns mapped to one or more constraints are derived from the action prong of the adaptation rules. In an aspect, the adaptation patterns mapped to the one or more constraints are represented by pattern IDs identifying an adaptation pattern. The choice of a particular adaptation pattern depends on the context-specific behavior that is required to be adopted in the workflow instance. In an example, a decision table may include “SparepartsInspection” segment ID and Customer Credit as constraints mapped to a “skip” adaptation pattern such that a sub-process for skipping the spare parts inspection process for customers with a low credit score is created. The credit status of the customer is determined from data-context variables associated with the workflow. The decision table serves as an interface for modifying the reference workflow's adaptive segments at the time of execution. For example, in order to make an ad-hoc adaptation of a workflow instance to a new context-specific behavior, at the time of execution of the workflow, an entity has to simply provide the constraints for adopting the context-specific behavior and the adaptation pattern that is required to execute the context-specific behavior, in the decision table.

At process block 240, the decision table is evaluated to determine whether one or more constraints in the decision table are met by the data context variables. In an example, the decision table is evaluated by comparing the current values of the data-context variables to the one or more constraints specified in the decision table. Based on comparing the one or more data-context variables it is determined whether one or more constraints in the decision table are true.

At process block 250, if one or more constraints are fulfilled, the adaptation patterns mapped to the fulfilled one or more constraints are identified. For example, the decision table may include a constraint relating to country and customer status, in which, if the country is “Germany” and the customer status is “high,” an adaptation pattern “timed message” is applied. Based on comparing the data context variables with the constraints in the decision table, if it is determined that the constraint Germany and high customer status is true, then the adaptation pattern “timed message” is selected as input for the pattern selector. If two or more constraints in the decision table are fulfilled, the corresponding adaptation patterns are provided as a nested list of adaptation patterns to the pattern selector. At process block 260, the selected adaptation patterns are provided as input to a pattern selector. In an aspect, the selected adaptation patterns are provided as a nested list to the pattern selector. The term “nested” as used herein refers to the wrapping of the adaptation patterns around an adaptive segment in a looped manner such that calling an adaptation pattern, by a selection process, recursively wraps back to a pattern selection process for calling the next pattern. In an aspect, the evaluation of the decision table is performed from top to bottom, accumulating (e.g., concatenating) the adaptation patterns which are then nested in a list.

At process block 270, the pattern selector recursively calls the adaptation patterns from the nested list of adaptation patterns. Executing a called adaptation pattern as a sub-processes, in turn loops back to the pattern selector, which calls the next adaptation pattern in the list until an end of the list is reached. In an aspect, the last row of the decision table links to the sub-process containing the content of the reference process for that segment. In such scenario, the pattern selector may recursively call the adaptation pattern sub-processes until the sub-process containing the reference process is called. At process block 280, the called adaptation patterns are executed as sub-processes within the adaptive segment.

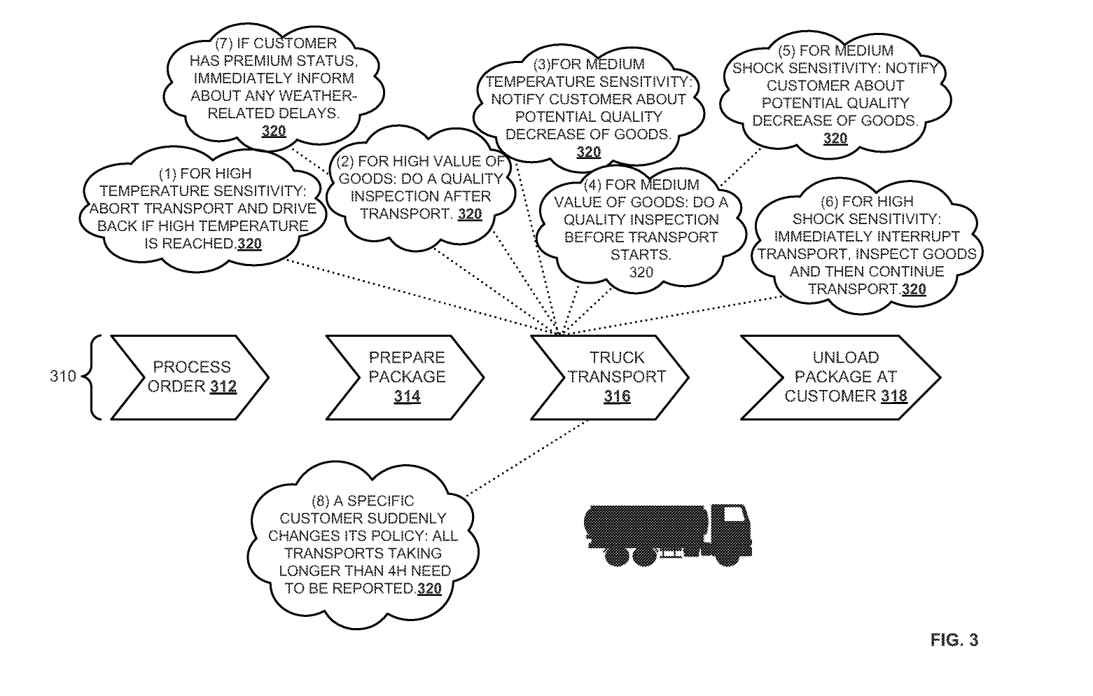

Consider a basically very simple logistics workflow for transporting a package from one location (e.g., goods hub) to another (e.g., customer site) depicted in FIG. 3. The basic workflow 310 in terms of a standard procedure consists of four steps: processing the transport order 312, preparing the package in the goods hub 314, i.e. boxing and sealing it, transporting the package to the target location 316 and finally unloading the package at the customer's location 318. The progress of the workflow can easily be monitored using state-of-the-art Internet of Things (loT) technology, e.g., RFID events. For such purposes, solutions already exist within the BPMN landscape. However the simplicity of the process is only preserved if the workflow instance in terms of a shipment is limited to the basic workflow 310 for a standard procedure. As it can also be recognized from the example scenario in FIG. 3, for the “truck transport” step 316 there are a few deviations 320 from the standard workflow which need to be accommodated by the supporting business process management system.

As shown in the basic workflow in FIG. 3, the deviations (1)-(8) 320 can be determined at the time of instantiation of the workflow. In the given example, such deviations 320 include 1) conduction of additional quality checks before or after the transport of the goods, 2) monitoring of weather forecasts, road traffic updates, and predicted delays, in order to provide additional services for premium customers, and 3) monitoring of various environmental conditions within the truck, e.g., temperature and turbulence. The process deviations may be necessitated by the nature of the goods being transported and other environmental factors. For example, for a commodity such as ice cream, it is not desirable to expose it to high temperatures during transportation. In another example, for a commodity such as wine, it may be necessary to intimate the customer if unfavorable conditions prevail within the transportation environment. The customer may then take a quality based decision on the immediate steps to follow.

Within the additional quality check paradigm, finer deviations may need to be tailored into the reference workflow. For example, for low value products, no quality check is required. For medium value products, a quality check at the supplier's site is required since the quality check at the supplier's site can be conducted more efficiently. For high value products, the quality check is conducted at the customer site to avoid any undue charges of damages against the logistics company, by the customer.

In order to accommodate these deviations 320 into business processes not only does the process logic for newly started workflow instances be altered, but also already existing instances need to be adjusted. For example, in FIG. 3, consider that the transport logistics workflow 310 is already running and is currently in the state of “package preparation” 314. An external event such as a change in customer's collaboration policy, demanding that every transport taking more than four hours needs to be immediately reported, necessitates a deviation 320 to the already running instances in the reference workflow 310.

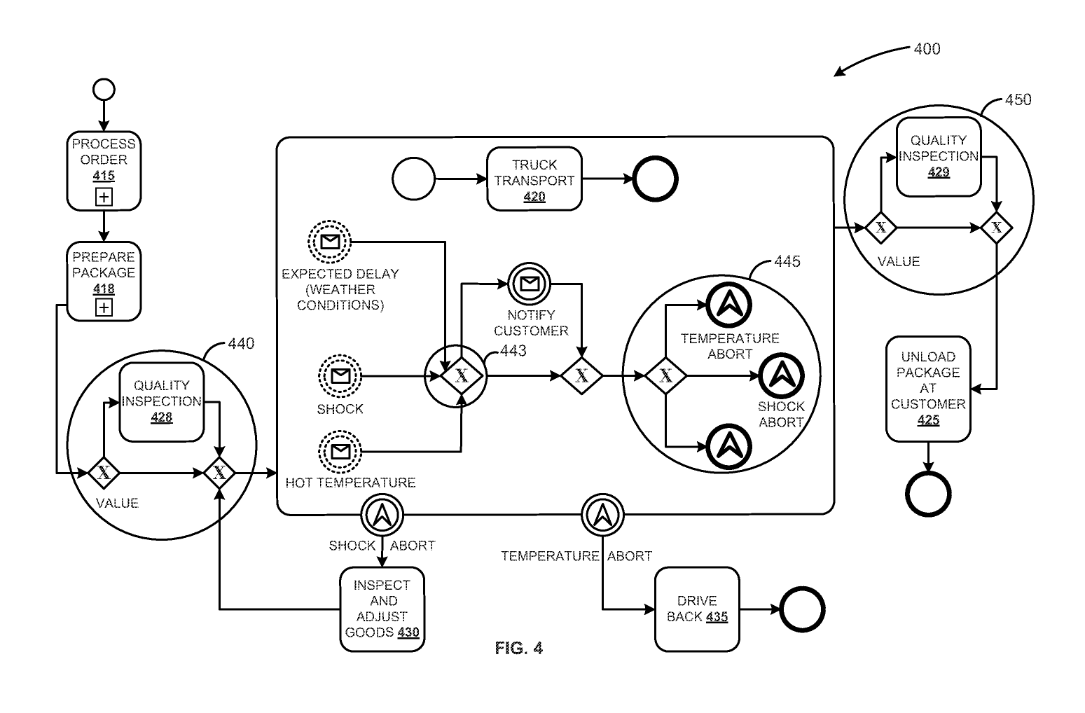

In conventional BPM solutions one can try to solve this modeling challenge by putting each possible process variant in one specific model. However, such a modeling process might lead to a large amount of models containing partly redundant business logic as explained with reference to FIG. 4.

FIG. 4 illustrates a workflow model in which the deviations (1) to (8) 320 as illustrated in FIG. 3 are modeled into the standard logistics workflow 400 at design-time. The workflow model 400 includes parts that constitute standard behavior such as the standard process steps “process order” 415 and “prepare package” 418 at the beginning of the workflow, “truck transport” 420 right in the upper middle of the workflow and “Unload Package” 425 at the end of the workflow. The remaining parts 428, 429, 430, and 435 constitute context-specific individual or exceptional behavior defined by the deviations (1) to (8) 320. However, four problem spots in this model are highlighted with circles 440, 443, 445, and 450 which result from two larger modeling problems namely 1) redundant context queries are introduced in order to realize the quality check requirement before and after the truck transport. However, from the flow model, it is not possible to determine whether the inspection can be executed twice or whether the two inspections are mutually exclusive, 2) several redundant modeling elements are used in order to realize the context-specific handling ofworkflow instances. For example, in order to prevent an “accidental” cancellation of a truck transport workflow instance, the events leading to a process deviation need to be configured as non-interrupting events. It is then checked to determine whether a notification needs to be executed. Afterwards, another similar context-query is executed to determine if a non-interrupting event has to become interrupting.

In summary, in the modeling technique described with reference to FIG. 4, if the behavior of the workflow for a specific customer or goods characteristics needs to be changed, the context-specific behavior at different parts of the actual model has to be identified and manipulated. Also, the workflow adaptation process becomes challenging if, as in the example given in FIG. 4, several context-dependencies (e.g., goods value, shock sensitivity, temperature sensitivity, and customer status) with different reaction patterns need to be integrated and combined in the process flow. And still, it is highly challenging, to integrate a new behavioral pattern like (8) in FIG. 3 into instances of the workflow model 400, during execution.

Accordingly, in an aspect, a combination of BPMN workflow models, adaptation rules, and adaptation patterns are used, as described in the following embodiments, in order to adapt segments of a workflow during execution to integrate new behavioral patterns specific to a customer, commodity, or other demography. In an embodiment, the adaptation approach is based on BPMN 2.0 workflow models. The BPMN 2.0 workflow model comprises facilities for execution details specification and event integration as well as an XML serialization format.

The approach includes two conceptual components which relate to specifying which parts of the reference workflow can change at the time of execution and defining which adaptations need to be applied for a particular data-context of a workflow. In an embodiment, the approach broadly includes the 1) specification of adaptable segments in the workflow that can be dynamically changed at the time of execution, 2) definition of adaptation patterns to be applied on the adaptive segments, 3) the formulation of adaptation rules which define a relation between the adaptive segments, data context variables, and adaptation patterns, and 4) the application of the adaptation patterns to the adaptive segments. The adaptive segments represent the parts of a reference workflow that can be changed during execution. The adaptation patterns define how the deviation of an adaptive segment from the reference process should be conducted. In an aspect, adaptations to workflows instances can be realized even after the workflow instances are started as the underlying implementation provides the flexibility to dynamically change the rule-sets. For example, by including an additional “instance selection” constraint in the condition part of a rule, ad-hoc changes to workflows can be realized during execution.

According to one embodiment, an “adaptive segment” is a construct introduced in order to indicate those segments in a workflow that can be changed during execution. The adaptive segments can be denoted with two different conventions for annotation: for example,
1. The adaptive segments can be marked with a distinctive kind of event nodes, e.g., event nodes with opening and closing square brackets [ ].
2. An adaptive single task can be marked by a black diamond “♦” in its upper left corner, with same semantics as (1), but being more space-saving. In an aspect, each adaptive segment is a block structured segment with one single entry point and one single exit point. Whenever such an adaptive segment is entered an entry event is thrown. This causes the workflow engine to evaluate the adaptation rules linking the adaptive segment, its data-context variables (data which determines the actual course of a workflow instance) and the adaptation patterns defined in the adaptation rules.

Adaptation patterns define how the deviation of an adaptive segment from the reference process should be conducted. They combine a natural language description and a BPMN definition of the adaptations. Also, the adaptation patterns describe how and in which situations an adaptation should be performed, enabling an end user to decide if and which adaptations should be performed during workflow execution. The term “adaptation” as used herein refers to the wrapping of sub-processes around a dynamic part of a segment in the workflow instance. Adaptation patterns are specified as parameterizable BPMN sub-processes having the following characteristics, for example:
Adaptation patterns contain an obligatory placeholder for the block-structured adaptive segment.
The adaptation patterns themselves also generally need to be block-structured (single entry, single exit). Exceptions consist in in the asynchronous triggering (forking) of events or the raising of exception events along the throw/catch hierarchy of a workflow.
The adaptation patterns may contain further placeholder elements such as task nodes, message or timer definitions from the BPMN2 meta-model.

The relation between various business situations in terms of the value of data-context variables and application of adaptation patterns can be established by formulating adaptation rules. In an aspect, the adaptation rules are defined in an event-condition-action (ECA) format. For example, a pseudo syntax for the adaptation rules can be defined as:
<ON entry-event IF conditions (based on data context) THEN APPLY adaptation pattern(s)>
   The “event” prong in the ECA rule corresponds to an entry to an adaptive segment. The “condition” prong constitutes value restrictions on context variables. The “action” prong corresponds to the application of parameterized adaptation patterns. In the given example a pseudo syntax similar to natural language is used.
   An example for such an ECA rule could be:
<ON TruckTransport_entry IF temperatureSensitivity=high THEN triggerEvent>

### Where,

Entry-event=entered adaptive segment TruckTransport,

Condition=high temperature, and

Trigger event=notify customer

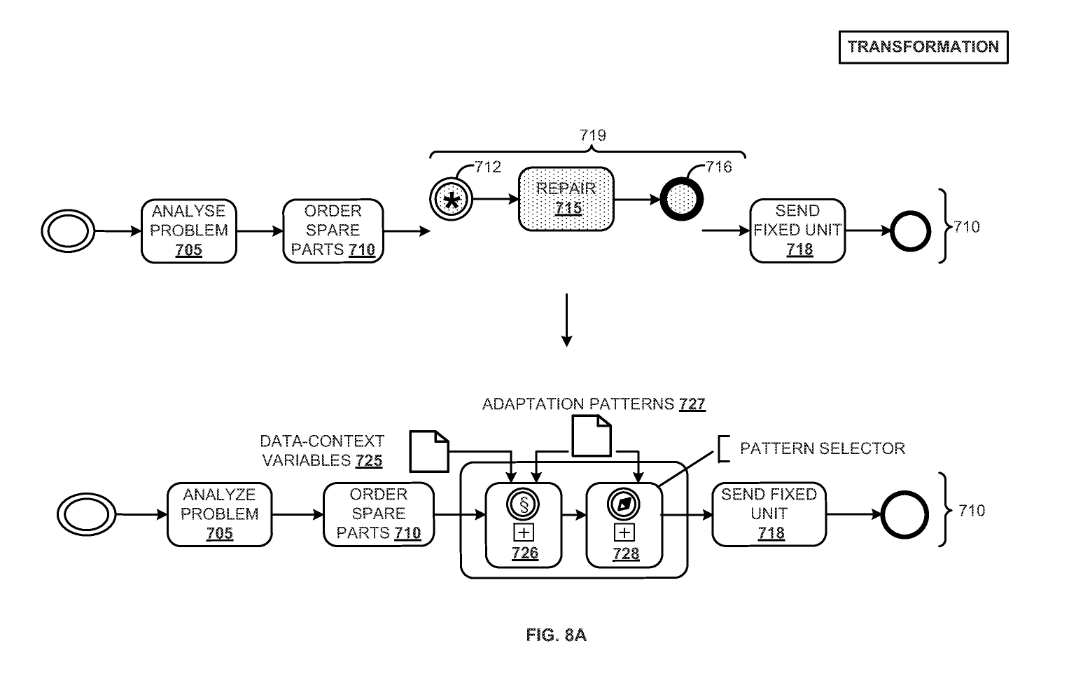

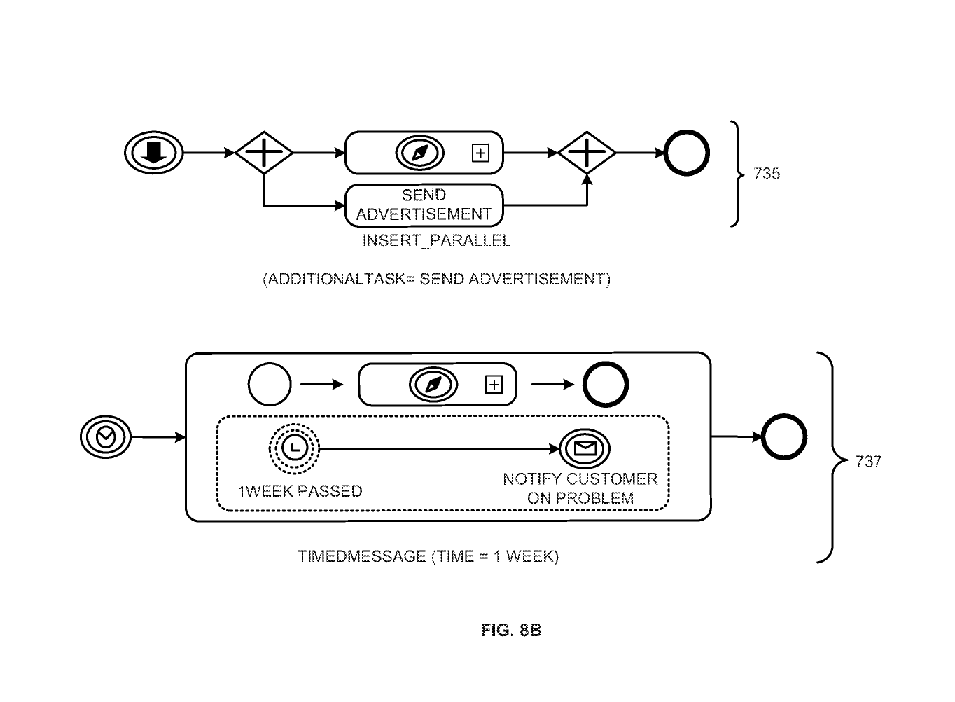

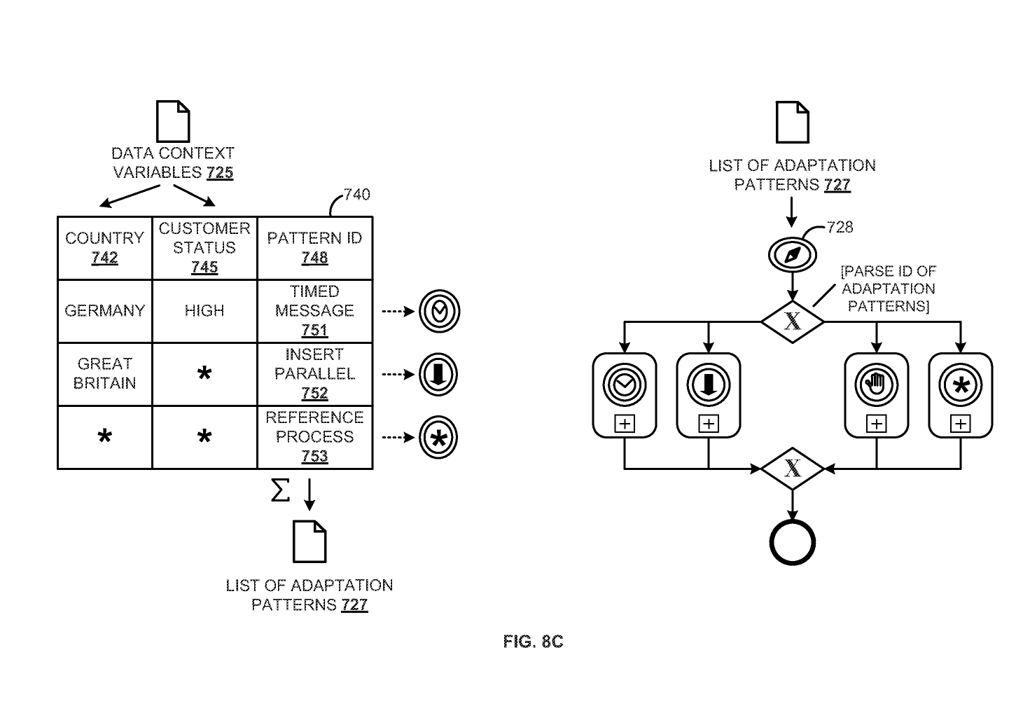

The given example rule defines that while the truck transport workflow instance is entered, any sensed high temperature is immediately forwarded to the customer as a notification. The truck transport task is wrapped with a sub-process, containing a non-interrupting catching event which triggers the notification event. In another embodiment, the adaptation rules may be defined using decision tables as will be explained in detail with reference to FIG. 8.

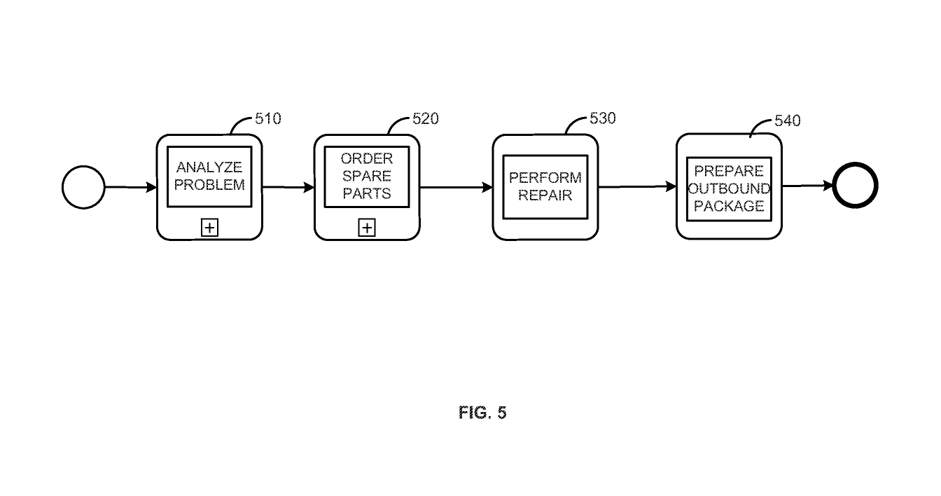

FIG. 5 illustrates an example scenario of a globally operating company offering repair services for electronic devices. On a coarse granular level as shown the workflow 500 can be described straight-forwardly in terms of four phases: problem analysis 510, material procurement 520, repair conduction 530 and the shipment 540 of the fixed unit. However, the different process stakeholders within the company may have varying additional requirements on the process, relating to the repair phase 530. The requirements may for instance depend on country, customer type, or repair type (warranty or paid order). Accommodating such requirements may cause slight deviations in the standard procedure, leading to process variants. For example, a special requirement such as a Greek country subsidiary requiring that all orders received from Greek customers be revised before order execution in order to ensure liquidity has to be immediately considered for already running workflow instances of workflow 500.

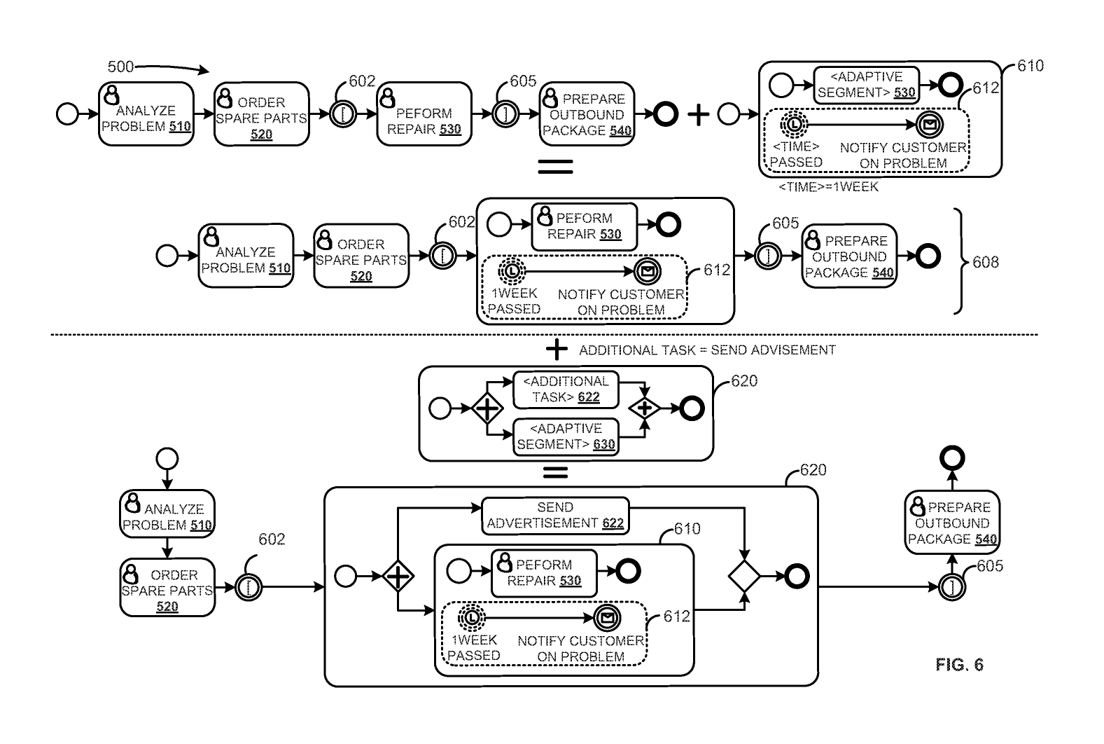

In order to dynamically integrate process deviations at the time of execution, the concepts for the adaptation ofworkflow instances that are already being executed are introduced. FIG. 6 illustrates an approach for flexible workflow modeling and execution using a Variant BPMN(vBPMN) as an extension of the standard BPMN2 meta-model. The vBPMN approach includes three conceptual components namely: a facility to marking variant (adaptive) segments in a workflow, a catalogue of reusable adaptation patterns, and a set of adaptation rules specifying where and for which business situation the patterns have to be applied.

In the example repair workflow in FIGS. 5 and 6, the requirements for process flexibility are focused on one part of the workflow, namely the “perform repair” 530 instance. In order to clearly separate the “static” parts of a workflow from those parts which may be adapted at the time of execution, vBPMN introduces two new node types “[” and “]” to indicate the start and end of an “adaptive segment” within a regular BPMN workflow definition. In an aspect, an adaptive segment is block structured in order to facilitate the use of adaptation patterns. The workflow itself however may be graph-structured. An example for the demarcation of an adaptive segment 530 is shown in the reference workflow 500 by nodes 602 and 605 in the upper part 608 of FIG. 6, which contains the single repair conduction task.

In an aspect, the structural adaptations which can take place for an adaptive segment are defined in an extensible pattern catalogue. In contrast to many systems realizing change patterns (e.g., insertion or skipping of tasks), exception-handling patterns (e.g., interruption of running tasks and restarting them) or time-constraint patterns (e.g., a time window during which a task can be executed), vBPMN does not define special semantics for the integration of these patterns with the process before or during execution. Instead, vBPMN relies on the workflow modeling language itself to specify the adaptation behavior. The advantages are that patterns are self-explaining and that they can be arbitrarily modified and extended. FIG. 6 contains two of such patterns 610 and 620 under the plus signs. A special characteristic of an adaptation pattern is that it always contains a placeholder for the underlying adaptive segment where it is applied to. By this, multiple patterns can be conveniently nested and combined during execution of the workflow. For instance, the first pattern 610 in FIG. 6 sends a notification after a specified time while the adaptive segment 530 is being executed. The second pattern 620 corresponds to the “classic” parallel insert pattern of an additional task.

The connection between different business situations in terms of the value of data-context variables and workflow tailoring operations (in terms of the application of parameterized adaptation patterns) is established by formulating rules in an event-condition-action (ECA) format. For example, the event of such an ECA rule may be the entry event to an adaptive segment. The conditions constitute value restrictions on context variables. The actions include the application of parameterized adaptation patterns. The adaptation patterns are parameterized with data-context variables. In an aspect, the adaptation patterns may be at least parameterized with an adaptive segment associated with the entry node of the rule's triggering event. A pseudo-syntax for the rule may be defined as follows, for example:

ON entry-event IF<data-context>THEN APPLY [<pattern((parameter, value)*)>]*
Where, “*” stands for O-n repetitions.
The execution semantics for adaptive workflow segments are now informally defined as follows: If an entry to an adaptive segment is signaled for a workflow instance, the context variables are evaluated and the segment eventually becomes subject to immediate adaptations before continuing through the segment. At each entry time to an adaptive segment, a consistent isolated variant segment is created which does not change even though a variable may change while the variant segment is executed.

FIG. 6 provides an example of the combined application of two pattern-based adaptations for the example repair workflow 500. The adaptation patterns 610 and 620 provide a placeholder for process deviations such as sending timed message 612 and performing additional task 622. For example, the deviation may require that in case the customer status is high and the country is Germany, then the customer needs to be notified upon a delay of one week. An additional or alternate process deviation could be that in case the customer country is Britain, then an advertisement has to be sent as an additional task to the reference task. As shown in FIG. 6, the two parameterized patterns 610 and 620 are applied on the adaptive segment 530 by wrapping the patterns 610 and 620 around the adaptive segment as extensions. The adaptation rules for the example repair workflow are as follows:

<ON performRepair_entry IF country=Germany AND
customerStatus=high
THEN APPLY timedMessage(time=1 Week)>
<ON performRepair_entry IF country=GreatBritain
THEN APPLY insert_parallel(additionalTask= ’Send Advertisement’)>

The vBPMN approach as described with reference to FIG. 6 supports:
Variant management—by explicitly indicating the static and variant parts of the process models. In an optimal case, i.e., if the adaptation pattern required for integrating a process deviation is a reusable generic pattern, then creating a new variant requires just adding a new rule. If a new custom behavioral pattern should be integrated, the engineering effort however is still restricted to the engineering of the pattern itself, while the proper integration with the overall flexible workflow can be achieved automatically at design-time using the infrastructure provided by vBPMN.
Aspect orientation—because the adaptation patterns can (ideally) be maintained in separation from the rest of the models. By specifying adaptive segments with the same identifiers, it is also possible to realize aspect oriented behavior by invoking the same adaptation patterns at multiple spots within a workflow. The particular format of the pattern especially in terms of the placeholder task makes the patterns combinable.
Adaptation during execution—because the adaptation rules and the patterns themselves which are applied during the course of a workflow instance can be changed even after the instance has been started.

Due to the nature of the adaptive segment being block-structured and the adaptation patterns having the inner part of an adaptive segment as a placeholder, the patterns can be wrapped around each other. The resulting adaptive segment represents a layered process “onion,” having the reference workflow parts in its inner core and the adaptations around it. Adaptation in this context can therefore also be understood as an extensibility concept for processes. In certain scenarios, it might be necessary to apply several adaptations simultaneously. In order to prevent structural problems resulting from an incorrect adaptation order as well as to increase the understandability for the modeler, a globally valid order for a set of adaptations depending on their type can be pre-defined. One example for an adaptation order is as follows:

Insert<EventHandler<TimePattern<WaitFor<Loop<Spawn<Synch<Skip

According to the example order insert adaptations should always be done first of all adaptations. Skip adaptations should be done as last adaptations. This means that the skip adaptation overwrites all previous adaptations.

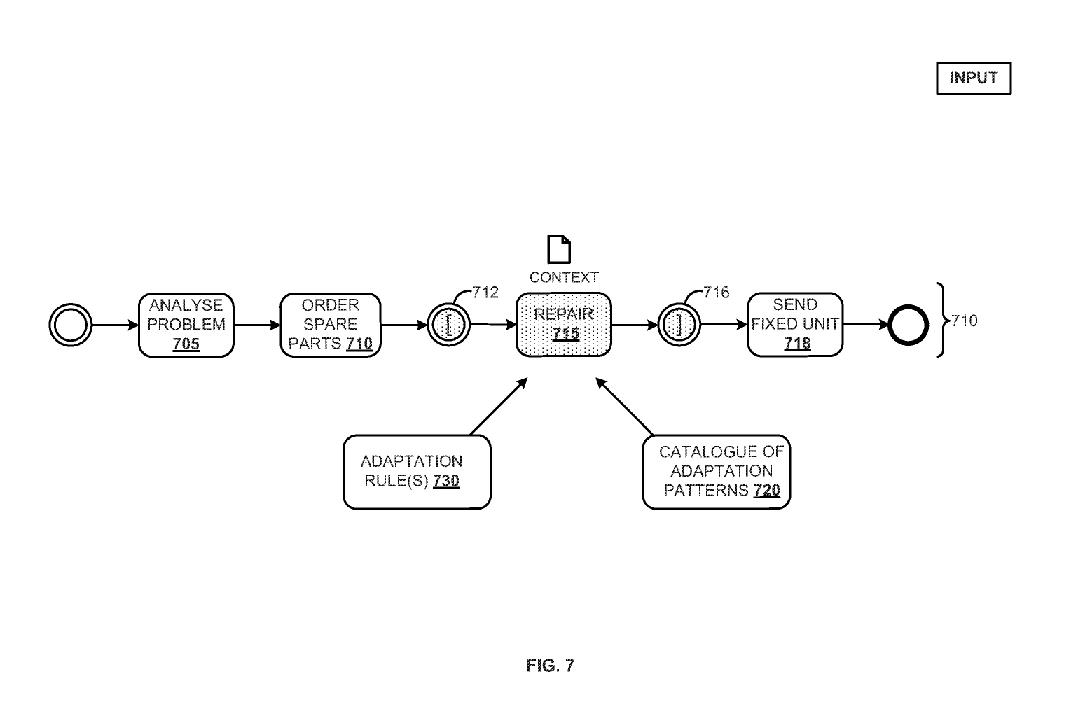

FIGS. 7 to 9 illustrate a model transformation approach according to an embodiment. The model transformation approach provides a procedure for automatic sub-process decomposition of the vBPMN model and the automatic generation of an explicitly modeled sub-process composition mechanism in standard BPMN2 model. FIG. 7 illustrates the required input models to be provided for the transformation procedure. The input model includes a reference model 710 with marked adaptive segments 715, a sub(set) of possible adaptation patterns 720, and optionally a set of adaptation rules 730. Whether a set of adaptation rules is required for the generation procedure depends on whether the adaptation patterns are fully pre-configured, i.e., they do not contain parameterizable elements besides the placeholder for the adaptive segment. If there are patterns with further parameterizable elements, the possible concretizations of patterns need to be determined first as a preparatory step by examining the action specified in the corresponding adaptation rules. The reference model includes workflow instances “analyze problem,” 705 “get material,” 710 “repair,” 715 and “send fixed unit,” 718 where the “repair” 715 workflow instance is marked as an adaptive segment by nodes “[” 712 and “]” 716.

A step-by-step walk through the transformation procedure is depicted in FIGS. 8A to 8C. Referring to FIG. 8A, at first, the “inner” content of each adaptive segment, i.e. a block structured segment demarcated by the square bracket nodes, is decomposed and extracted into its own sub-process. As shown in the example, the nodes of the adaptive segment “repair” 715 are removed from the reference model 710 and inserted into a newly created subprocess 719. The remaining demarcation nodes (square brackets) of each adaptive segment are treated likewise. As there is no specific element in the original BPMN2 meta-model to demarcate an adaptive segment, the BPMN2 meta-model is translated into a serial execution of a rule-set evaluation task by a sub-process node.

Secondly, a set of data context variables 725 associated with the workflow is provided as input data for the rule evaluation task ta sub-process 726. The output data of the rule evaluation task is a concatenated list of patterns 727 which need to be applied on the adaptive segment. The output data 727 of the rule evaluation task is in turn mapped as input data to a sub-process 728, which includes a “pattern selection” process. The actual control unit, which enables pattern based adaptations, called pattern selector is provided for performing the pattern selection process. The pattern selector acts as a construct to wrap the different adaptations around an adaptive segment. The pattern selector gets a list of adaptation patterns 727 as input and checks whether the list 727 is empty or not. If the list 727 is empty or if the end of the list is reached, the selection process 728 terminates. If not, the first element from the pattern list 727 is selected and the consequent path is determined according to the selected pattern. For each concretized adaptation pattern as well as for each subsequently extracted adaptive segment, an exclusive choice between the sub-processes is conducted. If a pattern is chosen at a subsequent selection by the pattern selector, the pattern selector receives a modified list with the remaining patterns to be applied as input.

Referring to FIG. 8B, in an aspect, as a third step 735, if there are patterns with parameterizable elements, e.g., additional task, timed message, etc., each pattern is first concretized with the action to be performed according to the provided adaptation rules in the input set. For example, for a pattern “insert task” specified twice in the adaptation rules with two distinct insertion task, such as send advertisement and send timed message, leads to the creation of two different concretized adaptation patterns. As shown, for each concretized pattern 735 and 737, the “adaptive segment” placeholder is replaced with a sub-process pointing to the “pattern selection” process. Each pattern concretization has in its input data-context variables and in its output a list of selected adaptation patterns.

Referring to FIG. 8C, fourthly, a decision table 740 is generated as follows: In an aspect, the decision table 740 may include a field to distinguish the different adaptive segments in the reference process using adaptive segment identifiers. Further, the decision table includes one or more fields 742 and 745 representing one or more constraints defined in the adaptation rules associated with the adaptive segment. Further, the decision table includes a pattern ID field 748 for providing an adaptation pattern type. The adaptation pattern type is mapped to an adaptation pattern that corresponds to the action defined in the adaptation rules. The rows 751, 752, and 753 can be automatically populated from the input set of adaptation rules if the rules complexity is low enough for being translated into a decision table format. Alternatively or in parallel they can be filled directly by a human process modeler or rule designer. In an aspect, the last row 753 of the decision table always links to the reference (standard) content of an adaptive segment for every segment and for every data context (marked with *). Interchanging of the row and column format and using other table formats are well within the scope of this embodiment.

The decision table 740 constitutes the point of interface for modifications of the reference process' adaptive segments during execution. When an adaptive segment 530 in the translated reference process is reached, it first evaluates the decision table 740 based on the current values of relevant workflow context variables 725. In an aspect, the evaluation of the decision table 740 is conducted from top to bottom, accumulating (concatenating) the patterns which need to be nested for the input data in a list 727. It then passes this list 727 to the pattern selector 728. The pattern selector 728 processes the list by calling the sub-processes defined by the adaptation patterns (which might recursively call the selector again), until it reaches the end of the list 727 or by calling the sub-process containing the extracted part of the reference process.

The above described generator approach simplifies the adaptation of workflow instances during execution. For example, assuming that an instance of the workflow in FIG. 5 is currently processing the task “order spare parts,” 710 a new requirement such as performing a special liquidity check for Greek customers has to be included into the reference workflow 710. If it is not possible to directly reuse a pattern from a pattern catalogue, one would model it in the required pattern format, run the above model transformation procedure, redeploy the pattern selector sub-process, deploy the new pattern sub-process and add a corresponding adaptation rule to the decision table 740. The liquidity check will now also be conducted for all new started and already running instances which have not passed the “perform repair” stage yet. As the above procedure is conducted fully automatically, the modeler does not have to be concerned with how the internal structures are generated. The decision table 740 can be offered to the modeler as a main means of workflow configuration and adaptation.

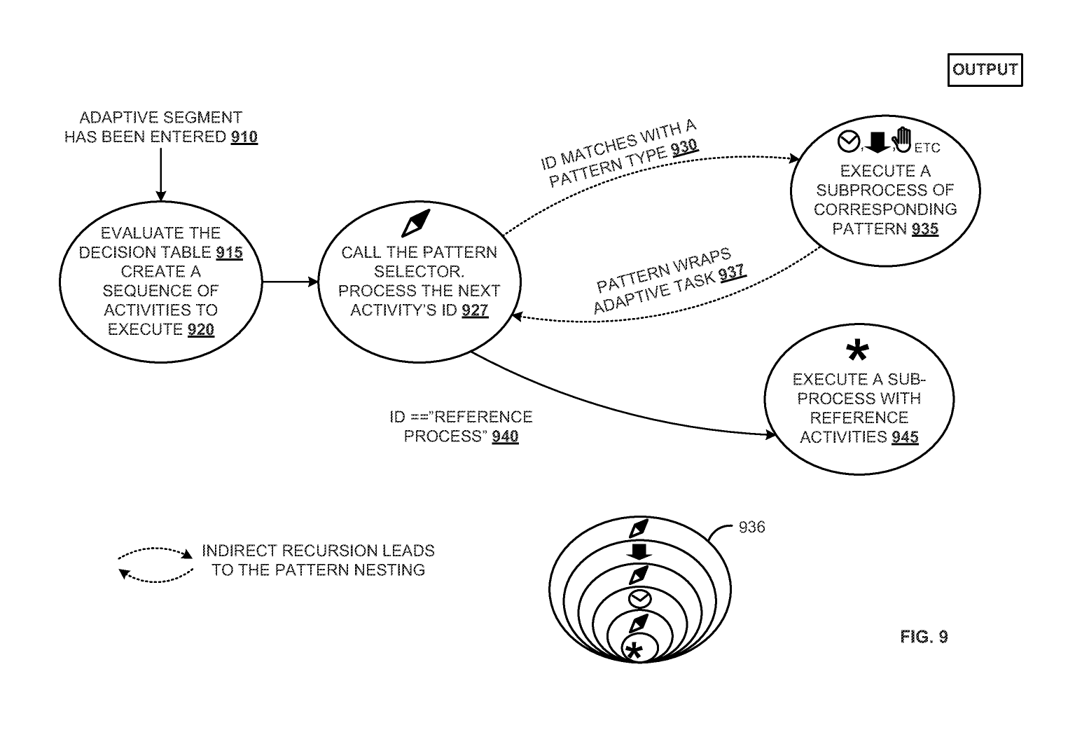

In FIG. 9, the special features of the resulting generated BPMN2 compliant model 900 are outlined. The model 900 now allows for the context-specific selection and composition of adaptations and the corresponding extension of the reference process. Compared to existing approaches to pattern composition, the patterns are not combined on the same “level” (e.g. just aligning them one after another), but in a recursive manner creating an onion-like structure, which is especially helpful if exception-handling concepts or time constraints need to be dynamically integrated. As shown in FIG. 9, when an adaptive segment is entered 910, the associated decision table is evaluated 915 and a sequence of activities defined by a set of adaptation patterns is created 920. The set of adaptation patterns is provided as input 925 to a pattern selector 927. The pattern selector 927 calls the patterns in the input set 925 one by one and determines whether a called pattern ID matches an adaptation pattern from a pattern catalogue. If a match is found 930, the sub-process corresponding to the matched adaptation pattern is executed 935. The adaptation patterns are nested in such a way that a called adaptation pattern recursively wraps 937 the adaptive task back to the pattern selection process until an end of the set of adaption patterns is reached or until a reference process ID is called 940. When the reference process ID (*) is called, the process executes 945 a sub-process having reference activities pertaining to the reference workflow.

The rule-based adaptation approach allows for the specification of multiple patterns and their application order for one specific data context. Due to its partly declarative nature however, multiple adaptations resulting from different adaptation rules or human intervention may need to be applied simultaneously. Different problems may occur if these adaptations are applied in an arbitrary order. One problem consists in the potential generation of unexpected or conflicting business logic. For example, if one rule defines the application of a skip pattern and one rule defines the application of an insert pattern, the workflow behavior, during execution, depends on the application order of the patterns. Another problem consists in the generation of structural errors within the workflow, for example when incorrectly mixing loop and dependency adaptations.

As an optional add-on to the model transformation approach, in order to prevent such structural problems resulting from incorrect adaptation order as well as to increase the understandability for the modeler, a globally valid order for a set of adaptations is defined. Such an order can be defined by carefully considering the potential interrelations of pattern types which are simultaneously applied w.r.t. interfering execution semantics. For example, a skip adaptation is always executed last, eventually “overriding” other adaptations. A loop adaptation is always executed before adaptations related to control dependencies, excluding the corresponding problems related to soundness violation. For loops, all loopback gateways should be inserted at the same place within the workflow, de-facto constructing a single loop which preserves all adaptations except synchronization and spawning configured when entering the adaptive segment. If rule conditions for adaptations should be reevaluated at loopback, this should be realized with a regular loop in the reference model. It is also possible to define different eventually use-case dependent global application orders. Although other reasonable orderings may exist, based on the given considerations, one valid application ordering can be defined as follows:

### Insert<EventHandler<TimePattern<WaitFor<Loop<Spawn<Synch<Skip

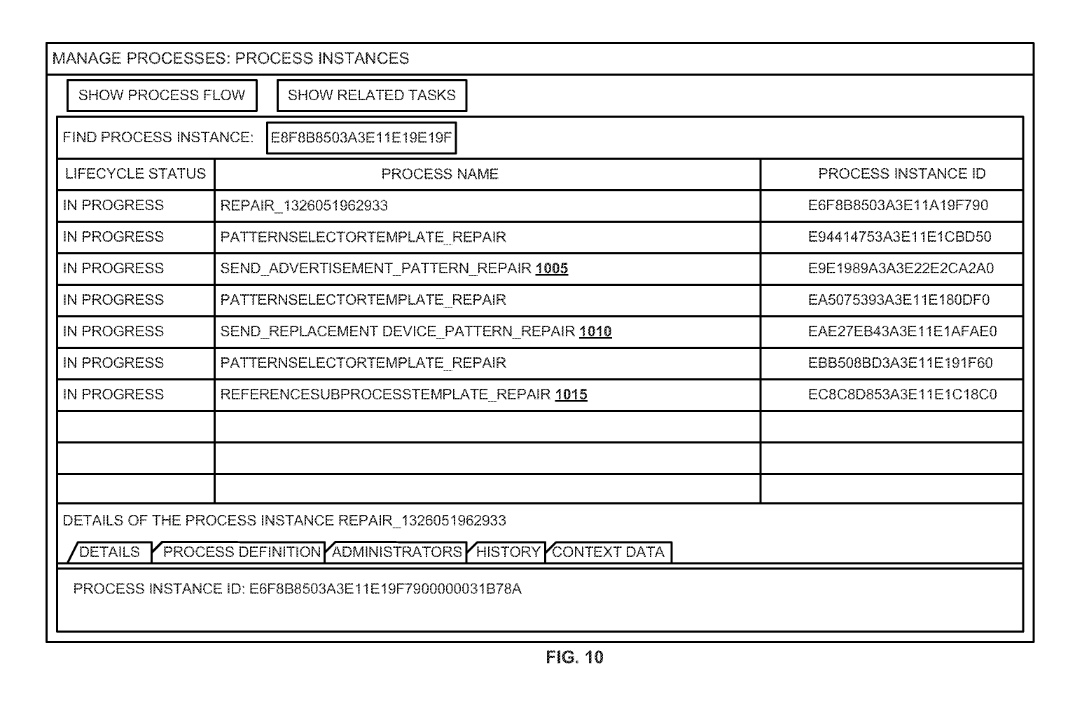

FIG. 10 depicts a resulting “process onion” within an execution engine for a workflow instance being executed. As shown, two adaptation patterns 1005 and 1010 are nested along with a reference sub-process 1015 using the decision table and the pattern selector.

Table 1 shows an example adaptation pattern that describes how an event can be asynchronously triggered while a segment is executed based on an incoming triggering event. Each pattern consists of a unique name, a description, a graphical representation in BPMN2 notation, an illustrative example as well as eventual parameters in terms of BPMN2 elements, and optional constraints restricting the usage of this pattern or its parameterization. The constraints refer to the conditions that have to be fulfilled for the valid application of certain adaptation patterns, in order to prevent structural errors that may result from adaptation during execution. In addition to the formal parts of an adaptation pattern that can be evaluated and applied by the BPM system, the pattern is written in natural language. It describes adaptations in a way understandable to human end users enabling an adaptation to be manually performed by an end user.

TABLE 1
Exception Handling Pattern EX8: Asynchronous Message Event Trigger

| | |
|---|---|
| Description: The adaptive | Example: On a change of environmental |
| segment is wrapped into a | conditions during a goods transport, this |
| sub-process containing a | change should be signaled to the |
| non-interrupting intermediate | transporter or the customer for later |
| message event, which | eventual manual quality inspection. |
| asynchronously triggers a | Parameters: Catch Event (BPMN2: |
| notification (message event). | MessageEventDefinition), Trigger event |
| | (BPMN2: MessageEventDefinition) |

Referring to Table 1, whenever an adaptive segment is entered an entry event is detected. This event causes the adaptation rules associated with the adaptive segment to be evaluated. The adaptation rules name the adaptations that have to be performed in a specific situation and may define the mere entry to the adaptive segment as an adaptation constraint. In situations where a context-specific behavior needs to be adopted into the reference workflow instance, the adaptation rules may define data-context variables as constraints to be fulfilled in order for an adaptation to be applied. Any additional segment that has to be provided, e.g. inserting a new segment, can be specified as a parameter. At each entry time to an adaptive segment, a consistent isolated variant segment is created. This variant segment instance does not change anymore while the segment is executing. If the same adaptive segment is entered multiple times, e.g., via a cycle in the workflow, the execution semantics allow for the creation of multiple different variants of the same segment. This allows adapting the segment to the actual workflow context.

Table 2 shows a simple example pattern for parallel insertion. A parallel insert pattern is invoked when an additional task need to be performed in addition to or concurrently with the already running reference instance.

TABLE 2
Basic Adaptation Pattern BAP3: Insert Element Parallel

| | |
|---|---|
| Description: When a segment of a | Example: In a maintenance |
| workflow is entered, an additional | workflow for machinery, |
| element is activated concurrently. The | additional checks on the |
| finishing of the segment in terms of | engine have to be performed |
| passing a token through its outgoing | while maintenance, for example |
| connector is delayed until the additional | if the engine stems from a |
| element has signaled completion. | specific engine manufacturer. |

For an example ship engine maintenance scenario, a “measurement” phase of reference workflow is extended to cover special occurrences in the maintenance history of the engine. An adaptation rule having “Insert Element Parallel” adaptation pattern in Table 2, in its action prong is as follows:

<ON measurements_entry IF
maintenanceHistory.contains(oilLeakageRepair)
THEN APPLY insert_parallel(segment=‘measurements_entry’,
additionalTask=‘integrityCheck’)>

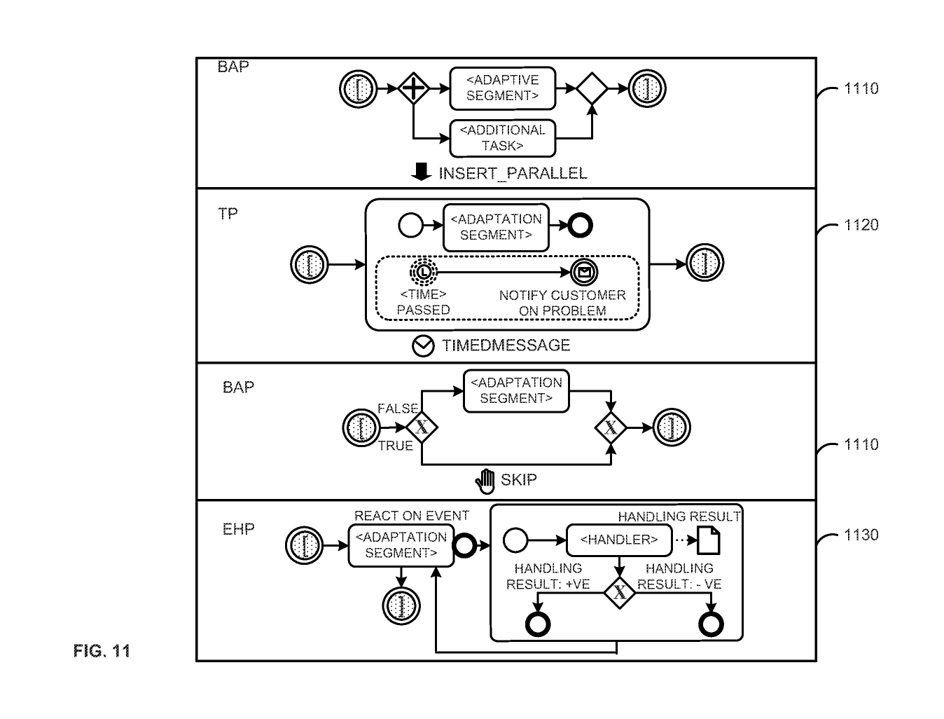

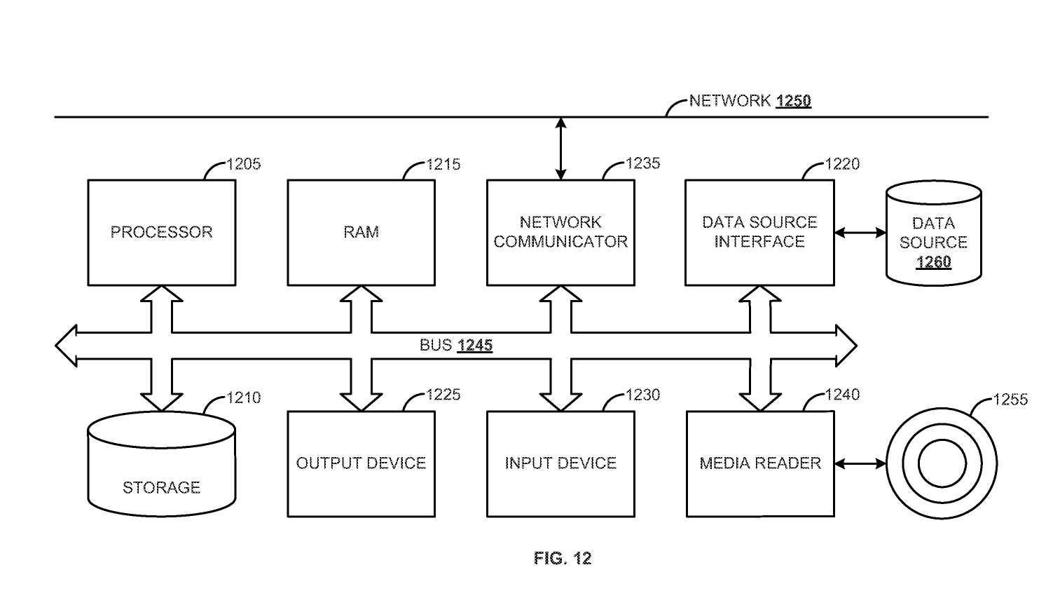

FIG. 11 shows an adaptation pattern catalogue 1100 covering and extending basic adaptation patterns (BAP), timed patterns (TP) and exception handling patterns (EHP). The patterns are divided into categories such as basic 1110, timed 1120 and exception handling 1130 and eventually mapped to generic patterns from existing prior work. Each pattern in the catalogue may include a unique name, a description, a graphical representation in BPMN2 notation, an illustrative example as well as eventual parameters in terms of BPMN2 elements, constraints restricting the usage of this pattern or its parametrization, reuse and refine relations to other patterns and correspondences to existing generic patterns. For example, some use cases might only require special exception handling mechanisms related to events occurring while the variant segment is execution, but without the need to alter the regular control flow at the point of adaptation. Other use cases may not require the “extension” of reference work flows during execution, where just the skip patterns could be enabled by a process modeler for rule-based integration with instances during execution.

The approach is based on a minimal-invasive extension of the BPMN 2.0 meta-model for marking context dependent adaptive workflow segments. One or more of the described embodiments provide for the automated generation of a flexibility infrastructure for workflows which emulates features like the adaptation ofworkflows and the context-dependent combination of simple, exception-handling and time constraint adaptations. A specific characteristic of the approach is the generation of BPMN compliant model artifacts which recursively create a stack-like “process onion” at the time of execution, whereas the normal flow parts reside in the middle of the onion and the adaptations are wrapped around it.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

FIG. 1200 is a block diagram of an exemplary computer system 1200. The computer system 1200 includes a processor 1205 that executes software instructions or code stored on a computer readable storage medium 1255 to perform the above-illustrated methods. The computer system 1200 includes a media reader 1240 to read the instructions from the computer readable storage medium 1255 and store the instructions in storage 1210 or in random access memory (RAM) 1215. The storage 1210 provides a large space for keeping static data where at least some instructions could be stored for later execution. The stored instructions may be further compiled to generate other representations of the instructions and dynamically stored in the RAM 1215. The processor 1205 reads instructions from the RAM 1215 and performs actions as instructed. According to one embodiment, the computer system 1200 further includes an output device 1225 (e.g., a display) to provide at least some of the results of the execution as output including, but not limited to, visual information to users and an input device 1230 to provide a user or another device with means for entering data and/or otherwise interact with the computer system 1200. Each of these output devices 1225 and input devices 1230 could be joined by one or more additional peripherals to further expand the capabilities of the computer system 1200. A network communicator 1235 may be provided to connect the computer system 1200 to a network 1250 and in turn to other devices connected to the network 1250 including other clients, servers, data stores, and interfaces, for instance. The modules of the computer system 1200 are interconnected via a bus 1245. Computer system 1200 includes a data source interface 1220 to access data source 1260. The data source 1260 can be accessed via one or more abstraction layers implemented in hardware or software. For example, the data source 1260 may be accessed by network 1250. In some embodiments the data source 1260 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A method of dynamically adapting a reference workflow according to changing data-context variables during execution of the reference workflow, the method comprising:
detecting an entry to an adaptive segment in the reference workflow;
invoking data context variables associated with the adaptive segment;
invoking a decision table comprising one or more constraints, on the data context variables, mapped to one or more adaptation patterns;
determining that at least one of the one or more constraints in the decision table are met by the data-context variables and selecting the adaptation patterns mapped to the at least one of the one or more constraints;
providing a list of the selected adaptation patterns as input to a pattern selector; recursively calling, by the pattern selector, adaptation patterns from the list of adaptation patterns; and
executing the called adaptation patterns as sub-processes within the adaptive segment.

2. The method of claim 1, wherein determining an entry to the adaptive segment in the reference workflow comprises detecting a demarcation node that is representative of the start of the adaptive segment.

3. The method of claim 1, wherein the decision table comprises at least one column representing the one or more constraints on data context variables and another column representing a corresponding adaptation pattern, wherein the one or more constraints are derived from one or more adaptation rules.

4. The method of claim 1, wherein determining that at least one of the one or more constraints in the decision table are met comprises determining that one or more of the data-context variables match at least one constraint in the decision table.

5. The method of claim 1, wherein providing the list of selected adaptation patterns further comprises recursively nesting the adaptation patterns as sub-processes within the adaptive segment.

6. The method of claim 1, wherein the one or more adaptation patterns are classified into basic adaptation patterns, exception handling patterns, and timed patterns.

7. The method of claim 1, wherein providing the list of selected adaptation patterns as input to a pattern selector comprises providing a list of pattern identifiers of the adaptation patterns to the pattern selector.

8. The method of claim 1, wherein the one or more adaptation patterns includes a placeholder for a sub-process in the adaptive segment.

9. The method of claim 1, wherein the reference workflow represents a regular course of a reference business process.

10. The method of claim 1, wherein each of the one or more adaptation patterns defines a deviation from the reference process for the adaptive segment.

11. The method of claim 1, wherein recursively calling, by the pattern selector, adaptation patterns from the list of adaptation patterns comprises calling the adaptation patterns, which in-turn call the pattern selector, until an end of the list is reached.

12. The method of claim 1, wherein the one or more adaptation rules are formulated in an event-condition-action (ECA) format in which, upon detecting an entry to the adaptive segment, if a defined condition is met, then a corresponding adaptation pattern is invoked.

13. The method of claim 1 further comprising:
receiving a request to adopt a new context-specific behavior in the reference workflow during execution; and
updating the decision table to include one or more new constraints for adopting the new context-specific behavior.

14. A method of configuring context-dependent adaptive workflow segments, the method comprising:
identifying at least one segment of a reference workflow as a segment subject to variation during execution;
marking the identified segment as an adaptive segment;
associating one or more workflow adaptation patterns with the adaptive segment, wherein each adaptation pattern of the one or more adaptation patterns includes a placeholder to add a context-specific behavior in the adaptive segment;
formulating one or more adaptation rules defining conditions for selecting an adaptation pattern from the one or more adaptation patterns; and
configuring a pattern selector to recursively call a nested list of adaptation patterns, wherein the nested list is generated based on evaluating the one or more adaptation rules using one or more data context variables associated with the adaptive segment.

15. The method of claim 14, wherein marking the identified segment as adaptive segment comprises demarcating the identified segment as adaptive segment using a distinct node type.

16. The method of claim 14, wherein generating the nested list of adaptation patterns comprises recursively nesting the adaptation patterns as sub-processes within the adaptive segment.

17. An article of manufacture, comprising:
a computer readable storage medium having instructions which when executed by a computer causes the computer to:
detect an entry to an adaptive segment in the reference workflow;
invoke a decision table comprising one or more constraints mapped to one or more adaptation patterns;
evaluate the decision table to generate a recursively nested list of adaptation patterns;
recursively call, by a pattern selector, adaptation patterns from the list of adaptation patterns; and
adapt the reference workflow to include the called adaptation patterns as sub-processes within the adaptive segment.

18. The article of manufacture of claim 17, wherein the recursively nested list of adaptation patterns wrap the adaptation patterns around the adaptive segment such that calling an adaptation pattern sub-process by the pattern selector in turn recursively calls the pattern selector until the end of the list is reached.

19. A system operating in a communication network, comprising:
a source system; and
a computer comprising a memory to store a program code, an interface, and a processor to execute the program code to:
detect an entry to an adaptive segment in the reference workflow;
invoke data context variables associated with the adaptive segment;
invoke a decision table comprising one or more constraints on the data context variables;
evaluate the decision table using the one or more data context variables and one or more adaptation rules;
generate a list of adaptation patterns based on the evaluation;
provide the generated list of adaptation patterns as input to a pattern selector;
recursively call, by the pattern selector, adaptation patterns from the list of adaptation patterns; and
execute the called adaptation patterns as sub-processes within the adaptive segment.

20. The system of claim 19, wherein the system is based on a variant Business process Model and notion vBPMN model.
